(19) United States
(12) Patent Application Publication
(10) Pub. No.: US 2009/0012910 A1
(43) Pub. Date: Jan. 8, 2009

(54) Method and system for gambling

(76) Inventors: Amos Azaria, Moshav Bet Gamliel (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/824,329

(22) Filed: Jul. 2, 2007

(51) Int. Cl. G06Q 40/00

(52) U.S. Cl. 705/36 R

(57) ABSTRACT

A method of gambling using the stock exchange as the basis of the stakes. Option to choose specific shares or options or groups of shares or options. Option to choose day tickets or period tickets. Option to choose “blind” or personally chosen shares or options. Made accessible to average person to purchase from street booths without the need to deal with broker.

### FIELD OF THE INVENTION

This invention is in the field of gambling and more particularly using the performance of certain shares or certain groups of shares or options to form the subject matter gambling.

### BACKGROUND OF THE INVENTION

Gambling has throughout the ages to the present time been known and practiced in a wide variety of forms and needs little introduction.

This invention comes to reveal a different type of gambling namely that the subject matter of the risk is shares of public companies or options to buy stocks or shares or commodities published by stock exchanges around the world. The individual would not need to buy shares, pay brokers and all that is involved in such transactions including reporting to the tax authority income and capital gains (in those states where there is requirement to report gambling gains).

Gambling games like roulette and random numbers chosen by a computer are pure luck type of gambling games. It is known in the art that the average statistical return on money spent on this kind of gambling is in the region of 80%. In contrast the average return on money spent on the stock market and on options in particular is close to 110%.

These statistics show that it is more worthwhile for a person to place his money on the stock market rather than regular lotteries. One difficulty is that the most people do not have a comfortable access to buying and selling on the stock exchange.

In most countries the law severely limits the activities of gambling operations. Trading in stocks, shares, commodities and the like is far less restricted. Usually the operator needs to have passed a training test and have a license to trade.

Another advantage of this innovation is the fact that the public often are cautious of conventional gambling outfits because of the fear of fraud. The movement of stocks and shares on the stock exchange is open for all to inspect. In any particular company there could be elements of fraud but the public are equally vulnerable to such fraud. This innovation would reduce suspicion of fraud at the points of sale.

The present invention, in some embodiments thereof, is a combination of knowledge, skill and luck, as is regular investment on the stock market. Knowledge means knowledge of the group of companies chosen or the sector of the market chosen for example pharmaceuticals or it could be the knowledge of a specific share or option. Skill refers to the ongoing analysis of the companies or the sector in order to make the best decision when to buy a lottery ticket and where possible, when to dispose of it. The luck factor is always present even when one has a good knowledge and skill because many times events can occur that will affect specific companies or groups of companies or specific sectors of industry. These unpredictable events often have a significant effect on the shares of those companies, sometimes for the good and sometimes for the bad. Outside and seemingly unrelated factors may also be part of the luck aspect for example, outbreak of war or extreme weather conditions in a certain region could cut off supplies of essential raw materials or cause a reduction in production and therefore raise the prices and therefore profits of local manufactures.

This invention reveals various alternative methods for the average person to, in effect, buy shares or options in the form of a card or ticket from a regular street lottery booth. It will encourage people to invest in the stock market. There will be a wider group of people investing in the stock market.

The purchaser could buy “blind” and try his luck or he could use his knowledge of companies or sectors of industry to choose specific shares or options to increase his chances of success. He could also choose the level of risk to which he wishes to be exposed.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

An object of this invention is to enable gambling using the published value of shares and/or the value of options of public companies being the subject matter of the gambling. Another object of this invention is to enable the body offering the gambling stakes to offer a particular share on which to gamble or a defined group of shares for example, the top 25 shares on the New York Stock Exchange, or five defined gold shares and the like.

Another object of this invention is to enable the purchase of a gambling ticket or card relating to a specific share or group of shares whereby the ticket will have on it the price or average price of that share or group of shares at a fixed time in the future.

Another object of this invention is to enable a purchaser of such a gambling ticket or card to sell it on to a third party as a negotiable instrument at whatever price the market justifies.

Another object of this invention is to enable a purchaser of such a gambling ticket or card to sell it back to the place or company that published it at whatever price the market justifies or at certain percentage of the purchase price at the choice of the publishing company.

Another object of this invention is to enable gambling in the share market without paying broker's fees.

Another option of this invention is for the purchaser to choose a ticket with just a number on it, where unknown to him, the ticket is allotted to a particular share or particular option. When he comes to collect his winnings, they will be based on the share or option price that day or other day, fixed at the time of purchase to be the date to cash in the “share ticket”.

Another option of this invention is for the purchaser to choose a number that is a share option for a specific day or for a specific period of time. He can come to collect his winnings after the stated time for collection and will receive winnings according to the price of the shares or options on the date fixed for the sale.

Another option of this invention is for the operating company that has sold a share ticket to a purchaser, to have the option whether or not to buy shares on the stock market parallel to those represented by the said ticket.

Another option of this invention is for the share tickets to be sold from gambling booths commonly situated on public streets and other premises of gambling.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 shows a graph of a share value over a time period.

FIG. 2 is a schematic depiction of a lottery ticket anticipated by this invention.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

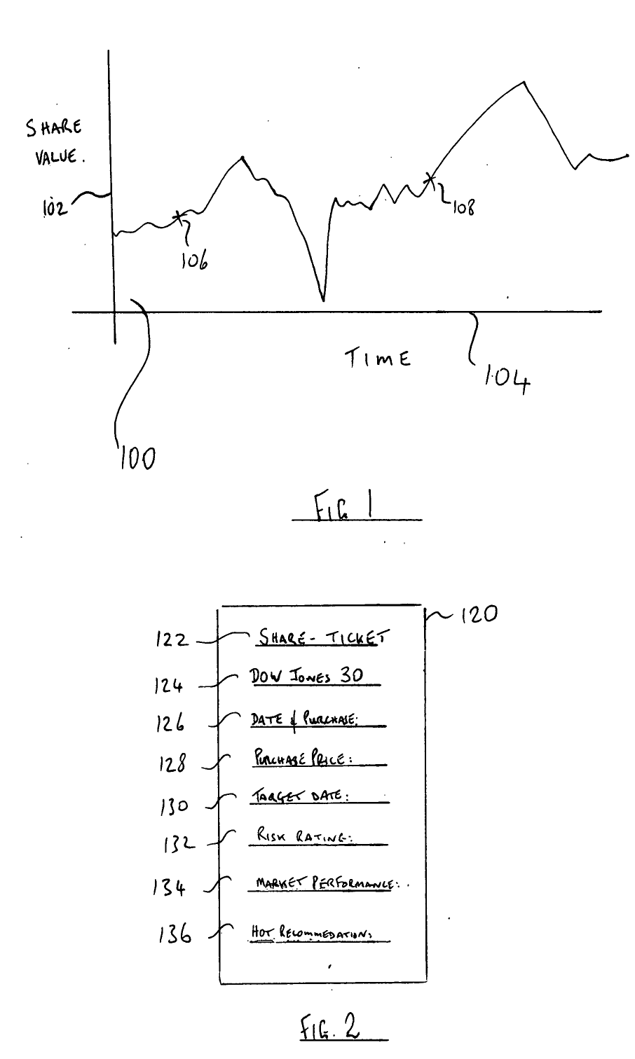

FIG. 1 shows an example of a graph 100 of the value of a share 102 or a group of shares or an option over a period of time 104. The value of the shares on the day of purchase is shown at the co-ordination 106. The purchase ticket could have written on it a date in, for example, one month's time (“the target date”). When the target date is reached the shares or options the value is shown at the co-ordination 108. When the purchaser comes to cash in his ticket at a later date he will receive the value as it was on the target date.

FIG. 2 shows an example of a lottery ticket 120 as anticipated by this invention. Its title 122 would indicate that the ticket is not a regular lottery ticket but a ticket connected to the share market. It would also indicate the agreed share or group of shares in this example being the Dow Jones 30 industrial average 124.

The date of purchase 126 would be marked as would the price paid 128 for the ticket 120. The ticket 120 would reflect the agreement between the purchaser and the issuer of the ticket 120.

If the ticket is for a specific period the target date 130 would be recorded on the ticket.

The risk rating 132 of the particular shares or options could be noted on the ticket to remind the purchaser at which level of risk he made his purchase.

The ticket could be computer generated and thereby contain other information like the market performance 134 over the last period say, month, of those shares chosen. Also it could include the latest recommendation for a purchase 136 to encourage further business.

What is claimed:

1. A method of gambling operated by an operator comprising;
a) determining the price for an investment ticket based on the price of specific company shares,
b) determining a target date to cash-in the said ticket,
c) determining the cash-in price based on the price of the said shares on the said target date,
whereby investors can gamble on the performance of shares on a stock market by buying and cashing-in the said tickets without buying shares directly from the said stock market.

2. A method of investment as claimed in claim 1 wherein the shares are those of public companies published by recognized stock exchanges.

3. A method of investment as claimed in claim 1 wherein the said investor chooses a category or group of said shares.

4. A method of gambling as claimed in claim 1 wherein the subject matter of the gambling is share options.

5. A method of gambling as claimed in claim 1 wherein the subject matter of the gambling is commodity options.

6. A method of gambling as claimed in claim 1 wherein there is a fixed cash-in price thereby enabling the sale of the said shares before the time fixed for the said investor to collect his money.

7. A method of gambling as claimed in claim 1 wherein the said target date is agreed to be on presentation of the said ticket to the said operator.

8. A method of gambling as claimed in claim 1 wherein the said investor can purchase a ticket number without knowing the shares or options represented by that ticket.

9. A method of gambling as claimed in claim 1 wherein the said investor can purchase a gambling ticket according to the level of risk that he desires.

10. A method of gambling as claimed in claim 1 wherein the said gambling ticket is transferable to a third party subject to the conditions and together with the benefits of the said ticket at the time of issue.

11. A method of gambling as claimed in claim 1 wherein the said investment tickets are sold at gambling street booths and other gambling premises.

12. A method of gambling as claimed in claim 1 wherein the said operator is not obliged to buy shares from the stock market in parallel with the shares represented by the said ticket.

13. A method of gambling comprising;
a) determining the price for an investment ticket based on the price of specific company shares,
b) determining a target date to cash-in the said ticket,
c) determining the cash-in price for the said ticket on the said target date,
d) the investor not knowing the said specific shares on which the price of the said ticket is set,
whereby investors can gamble on the performance of shares on a stock market by buying and cashing-in the said tickets without buying shares directly from the said stock market.

14. A method of gambling as claimed in claim 13 wherein the shares are those of public companies published by recognized stock exchanges.

15. A method of gambling as claimed in claim 13 wherein the subject matter of the gambling is share options.

16. A method of gambling as claimed in claim 13 wherein the subject matter of the gambling is commodity options.

17. A method of gambling as claimed in claim 13 wherein there is a fixed cash-in price thereby enabling the sale of the said shares before the time fixed for the said investor to collect his money.

18. A method of gambling as claimed in claim 13 wherein the said gambling ticket is transferable to a third party subject to the conditions and together with the benefits of the said ticket at the time of issue.
